(19) United States
(12) Patent Application Publication
(10) Pub. No.: US 2014/0328135 A1
(43) Pub. Date: Nov. 6, 2014

(54) MIXER FOR MANUFACTURING AND/OR TREATING A MEAT PRODUCT

(71) Applicant: Inotec GmbH Maschinenentwicklung und Vertrieb, Reutlingen (DE)

(72) Inventor: Miroslav Domlatil, Reutlingen (DE)

(73) Assignee: Inotec GmbH Maschinenentwicklung und Vertrieb, Reutlingen (DE)

(21) Appl. No.: 14/267,287

(22) Filed: May 1, 2014

(30) Foreign Application Priority Data
May 3, 2013 (DE) 10 2013 104 580.4

(51) Int. Cl. B01F 15/00

(52) U.S. Cl. CPC B01F 15/00
USPC 366/143

(57) ABSTRACT

In a mixer for manufacturing and/or treating a meat product in a mixing space (4) to which a lighting system (2) is assigned, the mixing space (4) is viewed by an image sensor (1).

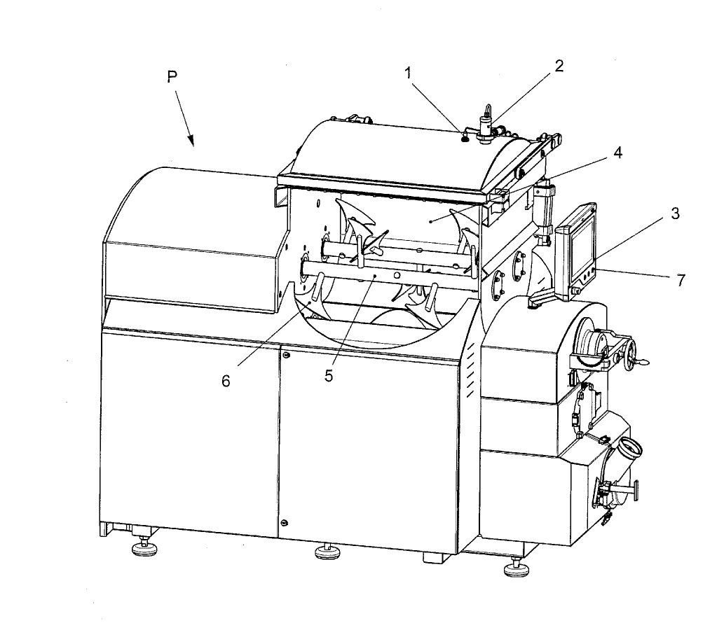

### BACKGROUND OF THE INVENTION

The invention relates to a mixer for manufacturing and/or treating a meat product in a mixing space to which a lighting system is assigned.

DE 69623329 T2 discloses, for example, a method and a device for mixing and analyzing foodstuffs, feed or medicinal products, and, in particular, meat. Minced or comminuted meat is conventionally manufactured from raw materials in the form of meat and fat which are obtained when parts of slaughtered animals are processed and prepared. The raw materials are coarsely comminuted to a particle size of 10 to 15 mm and arranged in respective containers or troughs, one of which contains, for example, purely meat and the other meat containing fat or possibly purely fat. The desired composition of the finished product is provided by mixing the various types of meat raw materials and fat raw materials in predetermined ratios, with the result that the mixture meets predetermined specifications in terms of fat, protein, etc. If the specific ratio has been achieved, the raw materials are mixed in the best possible way without them being spoiled by “overmixing”. Subsequently, the mixture is discharged from the container and finally comminuted to the desired particle size, for example by an appropriate mincer, after which the product is used to manufacture sausage stuffing or other products.

However, in many cases it is sufficient if the state of the mixture is monitored only by considering the mixed material. For this purpose, the mixing container has what is referred to as a tank lighting system. This lighting system illuminates the mixed material. Therefore the operator can monitor the mixed material through a glass pane. For this purpose there is a lighting button which the operator presses when he wishes to look in. However, to do this he must usually stand on a pedestal in order to be able to look in at all. If the mixing container is large, it is impossible to view certain areas. However, there is no possible way of continuously following and documenting the mixing process.

The object of the present invention is to simplify significantly the monitoring of a mixer for meat products.

### SUMMARY OF THE INVENTION

The foregoing object is achieved by providing an image sensor for viewing the mixing space.

This means that there is no longer any need for a separate viewing window which can be soiled and always has to be cleaned. Furthermore, the operator also does not need to make any particular effort in order to obtain information about the state of the meat product. To do this, all he needs to do is to view the display or screen which is arranged at viewing height and within reach. The operator also does not need to look directly into the lighting system, with the result that his eyes are also not strained. As a result, the detection of the meat product or the state of the meat product is also significantly improved. These images and video recordings can also be stored in order to ensure traceability. The monitoring of the mixing process and the traceability are very important.

In particular a video camera is possible as an image sensor, but individual image cameras can also be used if desired.

In one preferred exemplary embodiment, the screen is at the same time also configured as an operating control panel and is provided with corresponding control elements for the mixer. These include, inter alia, a button for switching on the lighting system and also corresponding control elements for controlling the video camera.

### BRIEF DESCRIPTION OF THE DRAWING

The FIGURE is a schematic, perspective illustration of a mixer with image sensor in accordance with the present invention.

### DETAILED DESCRIPTION

With reference to the drawing, a mixer P according to the invention has an opened mixing space 4. Provided in the mixing space 4 are two shafts 5.1 and 5.2 on which there are mixing elements 6 which serve to mix a meat product.

The mixing space 4 is illuminated with a lighting system 2.

Likewise, a video camera 1 transmits images of the mixing space 4 to a screen 3. The screen 3 contains control elements for the mixer P and, inter alia, a button 7 for switching the lighting system 2 on and off.

1. A mixer for manufacturing and/or treating a meat product, comprising:
a mixing space to which a lighting system is assigned; and
an image sensor for viewing the mixing space.

2. The mixer according to claim 1, wherein the image sensor comprises a video camera.

3. The mixer according to claim 2, wherein the image sensor is connected to a screen.

4. The mixer according to claim 3, wherein the image sensor includes a memory for videos and images which are produced by the image sensor.
